(19) United States
(12) Patent Application Publication
(10) Pub. No.: US 2012/0134535 A1
(43) Pub. Date: May 31, 2012

(54) METHOD FOR ADJUSTING PARAMETERS OF VIDEO OBJECT DETECTION ALGORITHM OF CAMERA AND THE APPARATUS USING THE SAME

(75) Inventors: Hung I. Pai, New Taipei City (TW); San Lung Zhao, Zhubei City (TW); Shen Zheng Wang, Taoyuan City (TW); Kung Ming Lan, Jiaoxi Township (TW)

(73) Assignee: INDUSTRIAL TECHNOLOGY RESEARCH INSTITUTE, Hsinchu (TW)

(21) Appl. No.: 13/194,020

(22) Filed: Jul. 29, 2011

(30) Foreign Application Priority Data
Nov. 30, 2010 (TW) 099141372

(51) Int. Cl. G06K 9/00

(52) U.S. Cl. 382/103

(57) ABSTRACT

An apparatus for a video object detection algorithm of a camera includes a video object detection training module and a video object detection application module. The video object detection training module is configured to generate an optimum correspondence between quantified values of environmental variables and parameters of a video object detection algorithm according to a stream of training video signals and a video object detection reference result. The video object detection application module is configured to perform video object detection on a stream of training video signals based on the optimum correspondence between the quantified values of the environmental variables and the parameters of the video object detection algorithm.

### BACKGROUND OF THE DISCLOSURE

1. Field of the Disclosure

The present disclosure relates to a video object detection method of a camera, and more particularly to a method for adjusting parameters of a video object detection algorithm of a camera.

2. Description of the Related Art

Image security monitoring has a very wide range of applications around our living environment. When thousands of cameras installed at all corners in a city send recorded videos to a master control room, the management and the identification of back-end images become arduous. Therefore, in order to realize the purpose of security protection, screen monitoring is performed by personnel. Another effective resolution is to utilize the function of smart video object detection of cameras. However, the stability of the function of smart video object detection is very important, and directly correlates to whether or not consumers are willing to accept smart cameras.

One of the factors influencing the stability of smart video object detection is the change of on-site environmental conditions, which include weather changes, movement of an object, changes in the reflection angle of an object, and various other elements. When a photosensitive device in a camera receives light and transmits an image to a back-end screen for display, due to partial or integral changes of light rays of a scene recorded by the camera, an error rate of the function of smart video object detection for image analysis is increased, and the stability and the practicability of the function of smart video object detection are reduced.

Many researches had been carried out to address the problem of the light ray changes, but most of the research is focused on development of an algorithm model for counteracting the light ray changes, and desired results are successfully produced only in some ideal cases. Moreover, some researches set focus on building models for solving specific weather situations, for example, for rainy days, a foreground detection model that is not affected by rain is proposed. However, there are many challenges in the development of a new algorithm to address the light changes. For example, when a new model needs to be developed, the original algorithm needs to be abandoned. In addition, the original hardware or embedded system needs to be re-designed, and the additional development cannot be based on the original infrastructure. Furthermore, the results of the prior research may require more computational complexity than is permitted by the old model, so that the practicability is reduced on real-time detection.

Accordingly, a method for adjusting parameters of a video object detection algorithm of a camera and an apparatus using the same are needed. The method can be built on the original algorithm platform without using excessive research time to develop additional algorithms, thereby avoiding the difficulties faced in prior research.

### SUMMARY OF THE DISCLOSURE

The present disclosure is directed to a method for adjusting parameters of a video object detection algorithm of a camera and an apparatus using the same, which can adjust algorithm parameters according to environmental factors. According to the method and the apparatus of the present disclosure, optimization processing can be performed to improve accuracy of a smart video object detection function in different scenarios without any additional information provided by a user, so as to minimize the interference of environmental factors on the algorithm. Accordingly, after a long period of operation, the algorithm can maintain stable performance.

The present disclosure provides a method for adjusting parameters of a video object detection algorithm of a camera. The method includes the following steps: receiving a stream of training image signals, and dividing each frame of the training image signals into a plurality of regions; determining quantified values of environmental variables of the regions of each frame of the training image signals; performing video object detection on the stream of training image signals according to a video object detection algorithm to generate a stream of video object detection results; changing parameters of the video object detection algorithm and repeating the step of the video object detection to generate a plurality of streams of video object detection results; and comparing the video object detection results with a reference result to determine an optimum correspondence between the quantified values of the environmental variables and the parameters of the video object detection algorithm.

The present disclosure provides an apparatus for a video object detection algorithm of a camera. The apparatus includes a video object detection training module and a video object detection application module. The video object detection training module is configured to generate an optimum correspondence between quantified values of the environmental variables and parameters of a video object detection algorithm according to a stream of training video signals and a video object detection reference result. The video object detection application module is configured to perform video object detection on a stream of image signals based on the optimum correspondence between quantified values of the environmental variables and parameters of the video object detection algorithm.

The technical features of the present disclosure have been briefly described above so as to make the detailed description that follows more comprehensible. Other technical features that form the subject matters of the claims of the present disclosure are described below. It should be understood by persons of ordinary skill in the art of the present disclosure that the same objective as that of the present disclosure can be achieved by easily making modifications or designing other structures or processes based on the concepts and specific embodiments described below. It should also be understood by persons of ordinary skill in the art of the present disclosure that such equivalent constructions do not depart from the spirit and scope of the present disclosure defined by the appended claims.

### BRIEF DESCRIPTION OF THE DRAWINGS

The disclosure will be described according to the appended drawings in which:

FIG. 1 is a schematic view of an apparatus for a video object detection algorithm of a camera according to an embodiment of the present disclosure;

FIG. 2 is a flow chart of a method for adjusting parameters of a video object detection algorithm of a camera according to an embodiment of the present disclosure;

FIG. 3 is another flow chart of a method for adjusting parameters of a video object detection algorithm of a camera according to an embodiment of the present disclosure;

FIG. 4 shows a frame of a stream of training image signals according to an embodiment of the present disclosure;

FIG. 5 shows a video object detection result according to an embodiment of the present disclosure;

FIG. 6 shows another video object detection result according to an embodiment of the present disclosure;

FIG. 7 shows a video object detection reference result according to an embodiment of the present disclosure;

FIG. 8 shows an optimum correspondence between quantified values of environmental variables and parameters of a video object detection algorithm; and

FIG. 9 shows another optimum correspondence between quantified values of environmental variables and parameters of a video object detection algorithm.

### DETAILED DESCRIPTION OF THE DISCLOSURE

The present disclosure provides a method for adjusting parameters of a video object detection algorithm of a camera and an apparatus using the same. In order to make the present disclosure more comprehensible, detailed steps and compositions are proposed in the following description. The implementation of the present disclosure is not limited to the specific details well known to persons of ordinary skill in the art. Furthermore, the well-known compositions or steps are not described in detail, so as to avoid unnecessary limitations on the present disclosure. Preferred embodiments of the present disclosure will be described in detail below, but in addition to the detailed description, the present disclosure can also be implemented in other embodiments, and the scope of the present disclosure is not limited thereto, and is defined by the following claims.

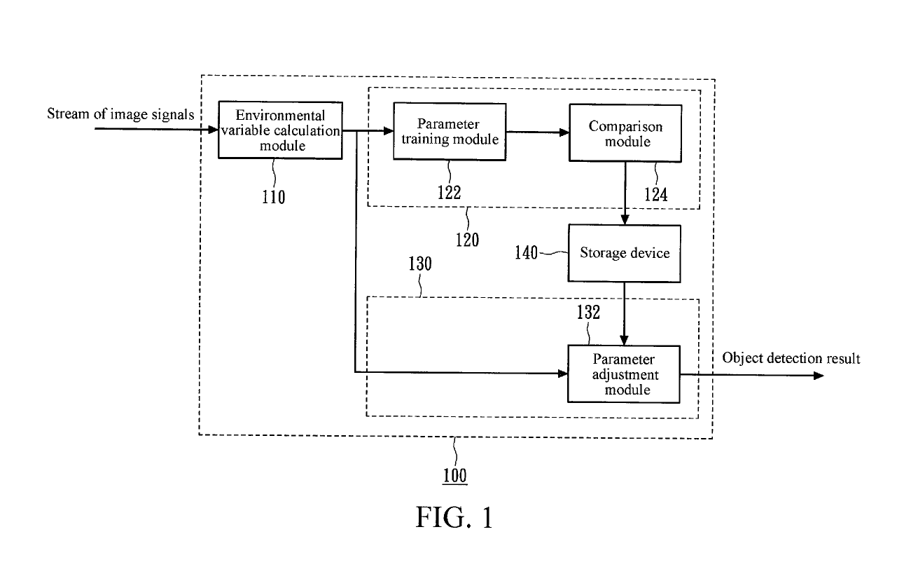

FIG. 1 is a schematic view of an apparatus for a video object detection algorithm of a camera according to an embodiment of the present disclosure. As shown in FIG. 1, the apparatus 100 includes an environmental variable calculation module 110, a video object detection training module 120, a video object detection application module 130, and a storage device 140. The environmental variable calculation module 110 is configured to calculate quantified values of environmental variables based on a stream of image signals for calculation of the video object detection training module 120 and the video object detection application module 130. The video object detection training module 120 is configured to generate an optimum correspondence between quantified values of the environmental variables and parameters of a video object detection algorithm according to a stream of training video signals and a video object detection reference result, in which the video object detection reference result may be pre-stored in the storage device 140. The video object detection application module 130 is configured to perform video object detection on a stream of image signals based on the optimum correspondence between quantified values of the environmental variables and parameters of the video object detection algorithm, so as to generate a stream of video object detection results. As described above, the apparatus 100 generates the optimum correspondence between quantified values of the environmental variables and parameters of a video object detection algorithm in advance by using the video object detection training module 120, and when video object detection is performed on a stream of video signals by the video object detection application module 130, the apparatus 100 selects corresponding optimum parameter values according to the current environmental variables and generates video object detection results. Therefore, the video object detection algorithm may be a known algorithm, so the purpose of realizing video object detection can be achieved according to different environmental factors without spending any additional time to develop a new algorithm.

Preferably, the video object detection training module 120 includes a parameter training module 122 and a comparison module 124. The parameter training module 122 is configured to generate a plurality of streams of video object detection results according to the stream of training image signals and different parameter values. The comparison module 124 is configured to compare the stream video object detection results and the video object detection reference result, so as to generate an optimum correspondence between quantified values of the environmental variables and parameters of the video object detection algorithm. Preferably, the comparison module 124 compares the streams of video object detection results and the video object detection reference result to select an optimum video object detection result, and the comparison module 124 determines an optimum correspondence between quantified values of the environmental variables and parameters of the video object detection algorithm according to the optimum video object detection result. The video object detection application module 130 includes a parameter adjustment module 132. The parameter adjustment module 132 is configured to perform video object detection on the stream of image signals according to the optimum correspondence between the quantified values of the environmental variables and the parameters of the video object detection algorithm, so as to generate a stream of video object detection results.

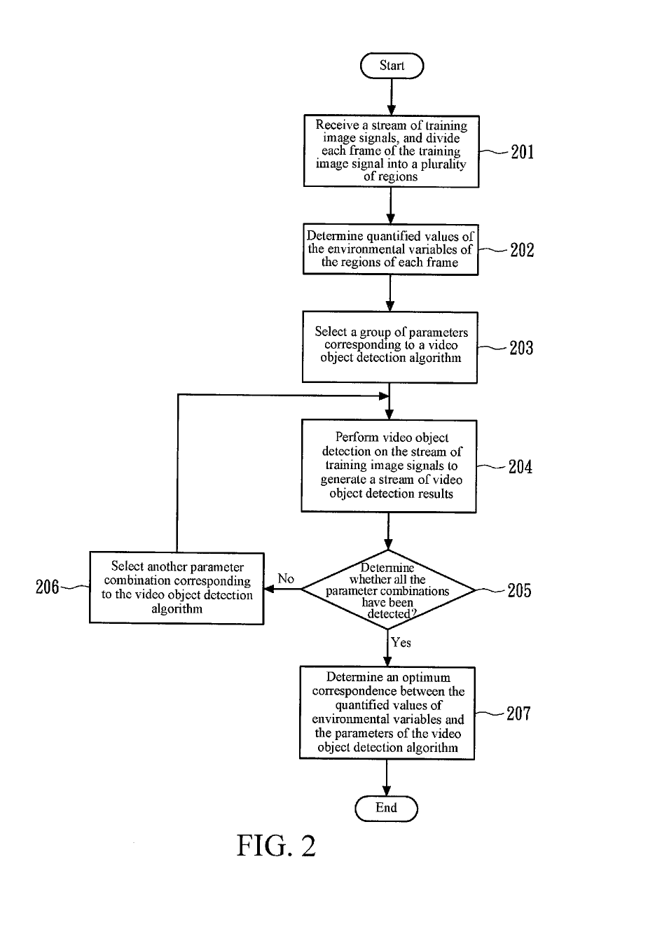

FIG. 2 is a flow chart of a method for adjusting parameters of a video object detection algorithm of a camera according to an embodiment of the present disclosure, in which the flow chart corresponds to the operation of the environmental variable calculation module 110 and the video object detection training module 120 in FIG. 1. In Step 201, a stream of training image signals is received, and each frame of the training image signals is divided into a plurality of regions, and Step 202 is executed. In Step 202, quantified values of the environmental variables of the regions of each frame of the training image signals are determined, and Step 203 is executed. In Step 203, a group of parameters corresponding to a video object detection algorithm is selected, and Step 204 is executed. In Step 204, video object detection is performed on the stream of training image signals according to a video object detection algorithm, so as to generate a stream of video object detection results, and Step 205 is executed. In Step 205, it is determined whether all the parameter combinations have been detected. If all the parameter combinations have been detected, then Step 207 is executed. If some of the parameter combinations have not been detected, then Step 206 is executed. In Step 206, another parameter combination corresponding to the video object detection algorithm is selected, and Step 204 is executed again. In Step 207, the video object detection results are compared with a reference result to determine an optimum correspondence between the quantified values of environmental variables and the parameters of the video object detection algorithm, and the method is ended.

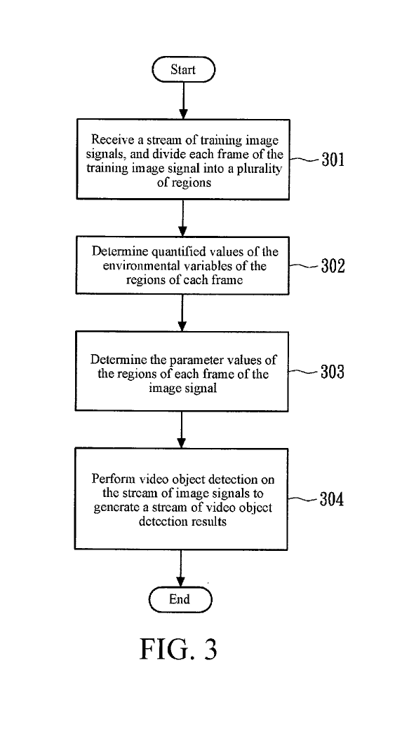

FIG. 3 is another flow chart of a method for adjusting parameters of a video object detection algorithm of a camera according to an embodiment of the present disclosure, in which the flow chart corresponds to the operation of the environmental variable calculation module 110 and the video object detection application module 130 in FIG. 1. In Step 301, a stream of image signals is received, and each frame of the image signals is divided into a plurality of regions, and Step 302 is executed. In Step 302, quantified values of environmental variables of the regions of each frame of the image signals are determined, and Step 303 is executed. In Step 303, according to an optimum correspondence between the quantified values of the environmental variables and parameters of the video object detection algorithm, the parameter values of the regions of each frame of the image signals are determined, and Step 304 is executed. In Step 304, video object detection is performed on the stream of image signals according to the video object detection algorithm and the determined parameter values, so as to generate a stream of video object detection results, and the method is ended.

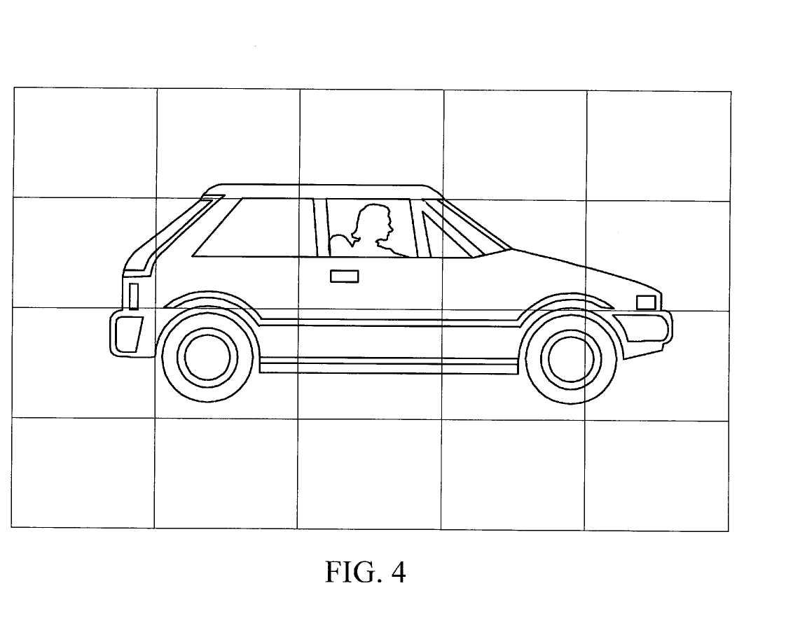

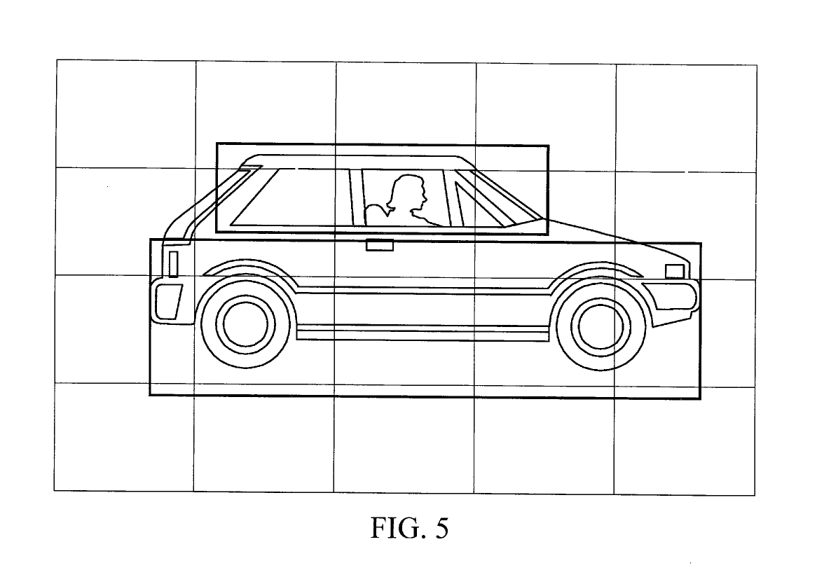

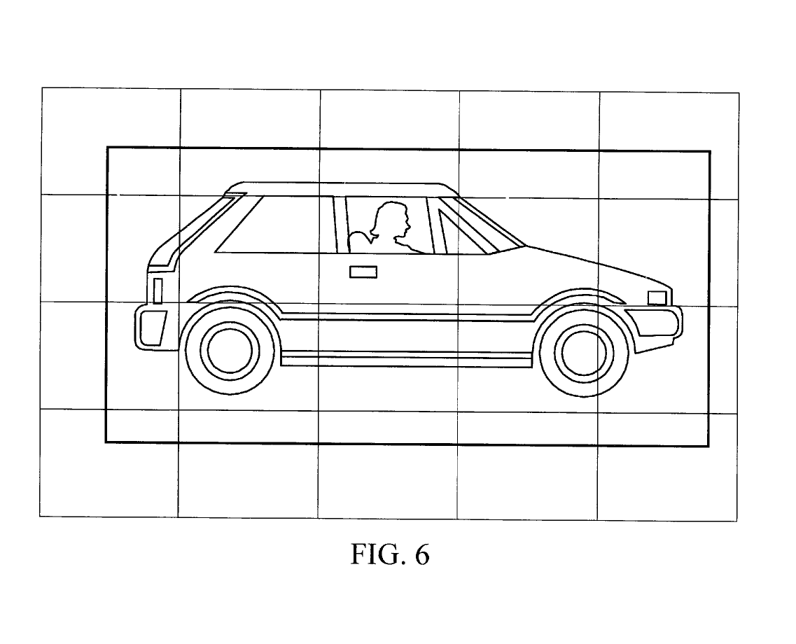

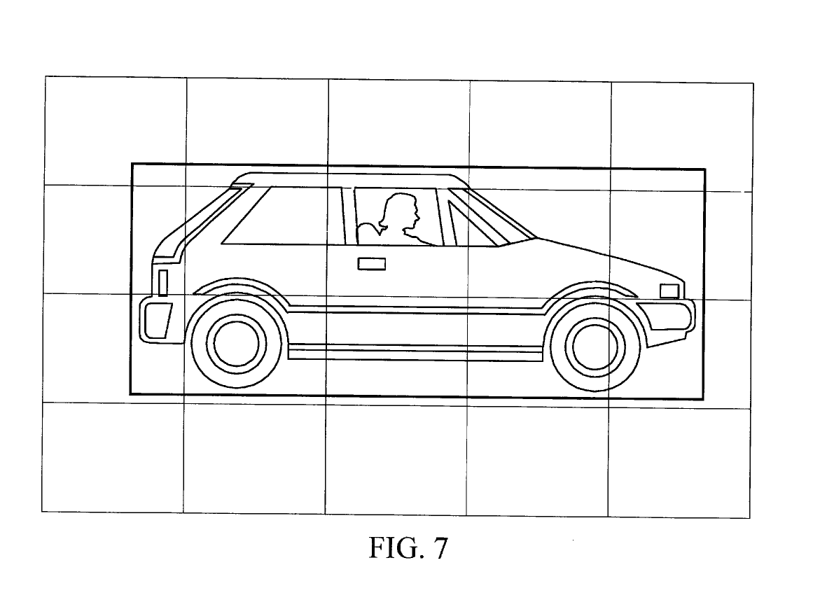

Embodiments of performing video object detection by applying the apparatus in FIG. 1 and the methods in FIG. 2 and FIG. 3 are exemplified. FIG. 4 shows a frame of a stream of training image signals according to an embodiment of the present disclosure. As shown in FIG. 4, the frame is divided into nᵣ regions according to Step 201. In Step 202, the environmental variable calculation module 110 calculates quantified values of environmental variables of the nᵣ regions of the frame. In this embodiment, the environmental variable is the image brightness. However, the environmental variable of the present disclosure is not limited to the image brightness, and may include the number of the objects, the type of the object, the size of the object, the moving speed of the object, the color of the object, the shadow of the object, weather conditions, and other environmental factors that may influence the video object detection result. In Step 203 to Step 206, the video object detection training module 120 generates a plurality of streams of video object detection results for all the different parameter values. FIG. 5 shows a video object detection result according to an embodiment of the present disclosure. FIG. 6 shows another video object detection result according to an embodiment of the present disclosure. FIG. 7 shows a video object detection reference result according to an embodiment of the present disclosure. In Step 207, by comparing the video object detection results in FIG. 5 and FIG. 6 with the video object detection reference result in FIG. 7, it is determined that the video object detection result in FIG. 6 is the optimum video object detection result. Similarly, for other frames of the stream of training image signals, a stream of optimum video object detection results can be obtained. According to the stream of optimum video object detection results, an optimum correspondence between the quantified values of the environmental variables and the parameters of the video object detection algorithm can be determined.

The calculation process of the method in FIG. 2 is described in detail below. It is assumed that a parameter p has nₚ adjustable values, for a region rᵢ (i is between 1 and nᵣ) of a frame, nₚ video object detection results can be obtained. Accordingly, for a frame divided into nᵣ regions, nₚ×nᵣ video object detection results are generated. In the comparison calculation in Step 207, a ratio of an overlapped area of the video object detection result of a frame and the video object detection reference result and a ratio of a non-overlapped area of the video object detection result of a frame and the video object detection reference result are compared, which are defined as follows:

Sₙ=A(P∩T)/A(T)

Sₚ=A(N∩F)/A(f−T),

where A(a) represents an area of a region a, f represents a set of pixels of the entire image, T is a set of object pixels in the video detection reference result, P is a set of object pixels of the video object detection result, F=f−T, and N=f−P. The accuracy of the video object detection result increases as Sₙ and Sₚ approach a value of 1. In other words, it is indicated that the parameter p used for resolving P is better. The comparison between the video object detection result and the video object detection reference result SC can be obtained through the formula below:

sc=(Sₙ+Sₚ)SₙSₚ/2

After all the possible combinations of the parameters have been tested, a complete fraction sequence {S₁, SC₂, . . . , SCₙ_{ₚ}ₙ_{ᵣ}} corresponding to the parameters is obtained. Among the fraction sequence, an element with a largest numerical value sc_{g} is selected. The corresponding detection result, P_{g}, is therefore the closest to the video object detection reference result, and the parameter p_{g} corresponding to the detection result P_{g} is the most suitable parameter combination under the test environmental condition. Accordingly, for the region rᵢ, the most suitable parameters {p_{g} (0), . . . , p_{g} (t), . . . , p_{g} (H)} at different time points can be obtained, in which H is the number of frames of the stream of training image signals. In combination with the quantified values of the environmental factors at different time points {S(0), . . . , S(t), . . . , S(H)}, corresponding relations between the quantified values of environmental variables and the parameters of a video object detection algorithm {(p_{g} (0)), S(0)), . . . , (p_{g} (t), S(t)), . . . , (p_{g} (H), S(H))} of the region rᵢ can be obtained, and can be organized into a two-dimensional data matrix M₀(rᵢ). If all the regions are collected, M̅₀={M₀(r₀), M₀(r₁), . . . , M₀(rₙ_{ᵣ})} is obtained.

Hereinafter, a region rᵢ is discussed. As the quantity of the data in the matrix is large, a quantified value S may correspond to a plurality of optimum parameters {p₁^{s}, p₂^{s}, . . . , pₙ^{s}}. Accordingly, in this embodiment, an average of the optimum parameters is taken as the most suitable parameter corresponding to the quantified value S of the environmental factor. If the standard deviation of the parameters is excessively large, for example, larger than a critical value, the parameters are not stable and can be abandoned. In this case, the optimum parameter corresponding to the quantified value S can be obtained via an interpolation method of other quantified values and the optimum parameters corresponding thereto.

After the above operation, a simplified two-dimensional data matrix M1 is obtained, and the dimension is nk×2, in which the quantified value S of each environmental variable only corresponds to one parameter pg, and the two-dimensional data matrix M1 is expressed as follows:

M₁=[PᵢSᵢ],

where,

$$P = [ \begin{matrix}{p}^{{s}_{1}} \\ ⋮ \\ {p}^{{s}_{{a}_{k}}}\end{matrix} ] , and S = [ \begin{matrix}{S}_{1} \\ ⋮ \\ {S}_{{n}_{k}}\end{matrix} ] .$$

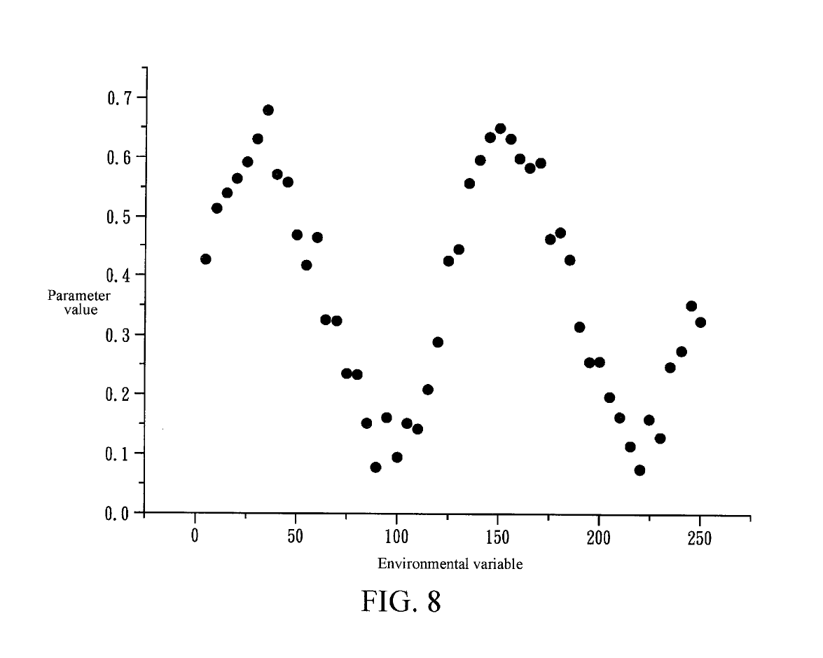

FIG. 8 shows an optimum correspondence M₁ between quantified values of environmental variables and parameters of a video object detection algorithm.

In order to further save the space in the storage device 140 for storing the optimum correspondence M₁ and reduce the noise of the data, the two-dimensional data matrix can be described by a polynomial function:

$$f ( S ) = {\sum }_{n = 1}^{m} {a}_{n} {S}^{n} ,$$

where m is an integer determined according to the conditions. The polynomial function may be expressed in the form of a matrix:

F= S̅A,

where F and A represent vectors having dimensions of nₖ and m, respectively, and S̅ is a matrix of nₖ×m. After substituting the two-dimensional data of M₁ into F and A in the linear equation, the matrix S̅ can be obtained. Furthermore, as for the matrix S̅, the singular vector decomposition (SVD) can be applied to obtain a pseudo-inverse matrix S̅⁺ of the matrix S̅. Accordingly, the vector A can be calculated using the following formula:

A= S̅⁺F.

The vector A in the original formula is substituted accordingly, and the polynomial function can be expressed as:

F=S S̅⁺P.

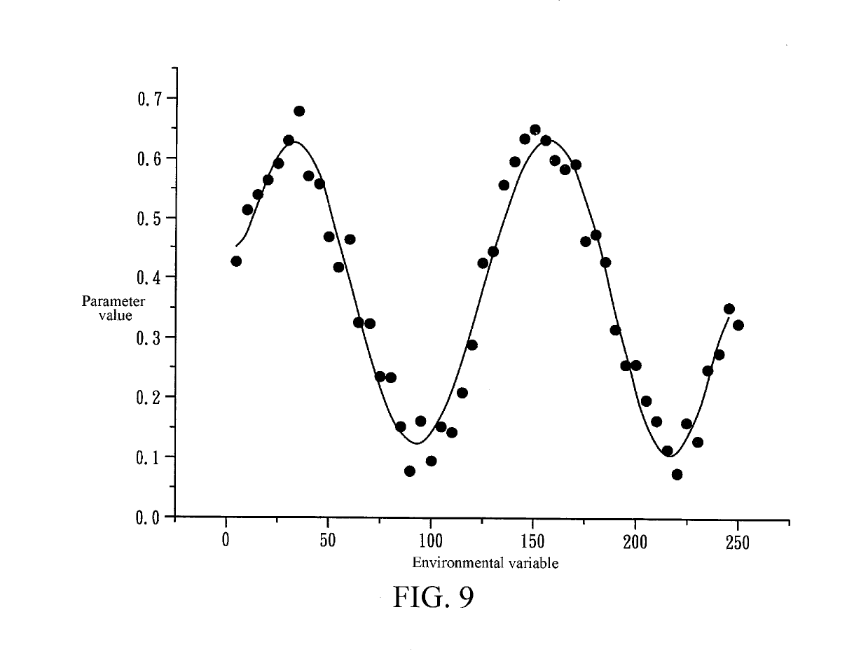

FIG. 9 shows a polynomial function F obtained through an operation according to the two-dimensional data matrix M1 in FIG. 8. The curve in FIG. 9 can also represent an optimum correspondence between the quantified values of environmental variables and the parameters of a video object detection algorithm.

In Step 301, as in Step 201, each frame of the image signals is divided into nᵣ regions. In Step 302, quantified values of environmental variables of the regions of each frame of the image signals are determined using the environmental variable calculation module 110. In Step 303, according to the optimum correspondence between the quantified values of environmental variables and the parameters of the video object detection algorithm, that is, the polynomial function F in FIG. 9, the parameter values of the regions of each frame of the image signals are determined. In Step 304, video object detection is performed on the stream of image signals according to the video object detection algorithm and the determined parameter values, so as to generate a stream of video object detection results.

In view of the above, the present disclosure provides a method for adjusting parameters of a video object detection algorithm of a camera and an apparatus using the same, which can adjust the algorithm parameters according to the environmental factors. According to the method and the apparatus of the present disclosure, optimization processing can be performed for the accuracy of a smart video object detection function in different scenarios without additional information provided by a user, so as to minimize the extent of interference of the environmental factors on the algorithm. Accordingly, after long-term operation, the algorithm can maintain the most stable performance.

Although the technical contents and features of the present disclosure are described above, various replacements and modifications can be made by persons skilled in the art based on the teachings and disclosure of the present disclosure without departing from the spirit thereof. Therefore, the scope of the present disclosure is not limited to the described embodiments, but covers various replacements and modifications that do not depart from the present disclosure as defined by the appended claims.

We claim:

1. A method for adjusting parameters of a video object detection algorithm of a camera, comprising the steps of:
receiving a stream of training image signals, and dividing each frame of the training image signals into a plurality of regions;
determining quantified values of environmental variables on each region of each frame of the training image signals;
performing a video object detection on the stream of training image signals according to a video object detection algorithm, so as to generate a stream of video object detection results;
changing parameters of the video object detection algorithm and repeating the step of the video object detection, so as to generate a plurality of streams of video object detection results; and
comparing the video object detection results with a reference result, so as to determine an optimum correspondence between the quantified values of the environmental variables and the parameters of the video object detection algorithm.

2. The method according to claim 1, further comprising the steps of:
receiving a stream of image signals, and dividing each frame of the image signals into a plurality of regions;
determining the quantified values of the environmental variables of each region of each frame of the image signals;
determining parameter values of each region of each frame of the image signals according to the optimum correspondence between the quantified values of the environmental variables and the parameters of the video object detection algorithm; and
performing the video object detection on the stream of image signals according to the video object detection algorithm and the determined parameter values, so as to generate a stream of video object detection results.

3. The method according to claim 1, wherein the comparing step comprises comparing the video object detection results and the reference result to select an optimum video object detection result, and determining the optimum correspondence between the quantified values of the environmental variables and the parameters of the video object detection algorithm according to the optimum video object detection result.

4. The method according to claim 1, wherein the optimum correspondence between the quantified values of the environmental variables and the parameters of the video object detection algorithm are expressed by a two-dimensional data matrix.

5. The method according to claim 4, wherein the two-dimensional data matrix is obtained by averaging different optimum parameter values corresponding to the quantified values of the environmental variables.

6. The method according to claim 4, wherein the two-dimensional data matrix is described by a polynomial function.

7. The method according to claim 6, wherein the polynomial function is obtained through a singular vector decomposition (SVD) of the two-dimensional data matrix.

8. The method according to claim 1, wherein the environmental variable is one of image brightness, number of objects, type of the object, color of the object, size of the object, moving speed of the object, shadow of the object, and weather conditions.

9. An apparatus for a video object detection algorithm of a camera, comprising:
a video object detection training module, configured to generate an optimum correspondence between quantified values of environmental variables and parameters of the video object detection algorithm according to a stream of training video signals and a video object detection reference result; and
a video object detection application module, configured to perform the video object detection on a stream of image signals based on the optimum correspondence between the quantified values of the environmental variables and the parameters of the video object detection algorithm.

10. The apparatus according to claim 9, further comprising:
a storage device, configured to store the optimum correspondence between the quantified values of the environmental variables and the parameters of the video object detection algorithm.

11. The apparatus according to claim 9, further comprising:
an environmental variable calculation module, configured to calculate the quantified values of the environmental variables of the stream of training image signals and the stream of image signals.

12. The apparatus according to claim 9, wherein the video object detection training module comprises:
a parameter training module, configured to generate a plurality of streams of video object detection results according to the stream of training image signals and the different parameter values; and
a comparison module, configured to compare the stream of video object detection results with the video object detection reference result, so as to generate the optimum correspondence between the quantified values of the environmental variables and the parameters of the video object detection algorithm.

13. The apparatus according to claim 9, wherein the comparison module compares the streams of video object detection results with the video object detection reference result to select an optimum video object detection result, and determines the optimum correspondence between the quantified values of the environmental variables and the parameters of the video object detection algorithm according to the optimum video object detection result.

14. The apparatus according to claim 9, wherein the video object detection application module comprises:
a parameter adjustment module, configured to perform the video object detection on the stream of image signals according to the optimum correspondence between the quantified values of the environmental variables and the parameters of the video object detection algorithm, so as to generate a stream of video object detection results.

15. The apparatus according to claim 9, wherein the optimum correspondence between the quantified values of the environmental variables and the parameters of the video object detection algorithm are expressed by a two-dimensional data matrix.

16. The apparatus according to claim 15, wherein the two-dimensional data matrix is described by a polynomial function.

17. The apparatus according to claim 15, wherein the two-dimensional data matrix is obtained by averaging different optimum parameter values corresponding to the quantified values of the environmental variables.

18. The apparatus according to claim 17, wherein the polynomial function is obtained through a singular vector decomposition (SVD) of the two-dimensional data matrix.

19. The apparatus according to claim 9, wherein the environmental variable is one of image brightness, number of objects, type of the object, color of the object, size of the object, moving speed of the object, shadow of the object, and weather conditions.
